(19) United States
(12) Patent Application Publication
(10) Pub. No.: US 2006/0182129 A1
(43) Pub. Date: Aug. 17, 2006

(54) Distributed markup and processing apparatus and method

(76) Inventors: Karl N. Mutch, Menlo Park, CA (US); Paul Devine, San Francisco, CA (US)

Correspondence Address: IPSG, P.C., P.O. BOX 700640, SAN JOSE, CA, 95170-0640, US

(21) Appl. No.: 11/127,913

(22) Filed: May 11, 2005

Related U.S. Application Data
(60) Provisional application No. 60/653,312, filed on Feb. 16, 2005.

(51) Int. Cl. H04L 12/56

(52) U.S. Cl. 370/401; 709/217

(57) ABSTRACT

An apparatus for performing XML processing distributed across one or more network entities and a terminal comprised of a mobile device entity. A memory stores a transformed representation of XML information. The network entity and terminal communications are mediated by a proxy tasked with offloading XML processing other operations from the network entities or terminals participating in communications exchanges and/or XML manipulations. Advantages of the invention include the ability for network operators to optimize communications techniques based on XML Documents, XML Fragments, communication protocol components, and other forms of XML interchange and exchange.

### RELATED APPLICATIONS

This application claims priority to U.S. Prov. No. 60/653,312 filed Feb. 16, 2005, incorporated herein by reference.

### FIELD

The present invention relates to processing structured data represented using the Extensible Markup Language (XML) across a plurality of network entities, and particularly for wireless communication.

### BACKGROUND

Communications protocols have become increasingly sophisticated as a means for representing constituent parts of data. Likewise, the amount of information embedded in the communications protocol has also increased. In order to support an orderly and meaningful exchange of information and data between communications entities, the Extensible Markup Language (XML) was created and has subsequently received widespread adoption. XML has also been enhanced with the ability to express complex relationships and rules for data that are used to verify the validity of data and information exchanged between communications entities.

As the expressiveness of communications protocols has increased standards bodies, institutions, and organizations to enrich and formalize communications methods across a wide variety of devices, and terminals and varied types of communications networks, for example wireless and wired, have adopted XML and its accompanying specifications.

However for those wishing to implement devices and terminals supporting these protocols, as is typically required, the processing burdens for dealing with the increased expressiveness of these standards and their various applications have created great complexity.

Networks employing constrained terminals, and especially those that experience communication bandwidth and latency limitations, such as those experienced by the wireless communications industry, have a particularly large burden for processing XML data in its various forms and applications. As an example, existing means of communicating data and information using the Extensible Markup Language (XML) between two, or more, parties using the Open Mobile Alliance, 3GPP, and IETF standards are costly for terminals to process.

What is needed is a technique by which terminals can experience the full range of XML features and benefits without being burdened with XML processing and communications overheads.

### SUMMARY

The invention provides an apparatus and method by which communication entities can experience the full range of XML features and benefits without being burdened with XML processing and communications overheads. The invention includes a means of processing XML Markup communicated between two entities across a communications network to achieve greater efficiency and an improved user experience for terminal devices.

The invention includes mechanisms by which terminals leverage the processing capacity of other network entities in order to reduce their cost of processing information and/or transmitting information, or data as is exemplified within the mentioned communications ecosystems.

An exemplary embodiment of a communication network comprises a terminal tailored to communicate with a communications network; and an XML proxy structure acting as a network entity, resident in the network, containing a plurality of representations of a portion of an XML document(s) for communication with terminals. Naturally a portion of an XML document may include one or more fragments or the whole portion thereof.

In one aspect of the invention, the representations of an XML document include at least one representation for efficiency and applicability to a specific terminal or class of terminals, and at least one other representation for interoperability with terminals not supporting the characteristics of the invention.

In another aspect, the invention further comprises a translation structure, resident in the network, configured to create suitable representations of XML document(s), or fragments thereof, for a plurality of different terminals.

In another aspect, the invention further comprises a management structure, resident in the network, configured to provide network operators network topology information through and within an OMA compliant Aggregation Proxy in order to communicate and describe available network services or features, or enhancements to said services and features.

One advantage of the invention is that equipment within the communications path can partially process information and data on behalf of the receiving and/or transmitting device(s), such as a User Equipment, a terminal, or a network entity. For example XML document(s) or fragments thereof, can be processed by the aggregation proxy to reduce the overhead of handling the information once it has arrived at its destination and also potentially to reduce the costs of the communications network transmitting said XML. The invention enables these savings to be made without disrupting devices already present within a communications network, for example IMS or OMA OSE protocols can still be used unaltered by terminals not able to utilize this method. To give this advantage, the invention provides an efficient XML discovery and processing that is more efficient than conventional techniques, while also more customizable for a variety of different terminal parameters and constraints, and network entities found within a communications network. Network servers implementing a particular XML or other document protocol need not be aware or implement any specific behavior in order for this method to be deployed; only the terminal and the network entity implementing this method need be aware of its usage.

### DESCRIPTION OF THE DRAWINGS

The foregoing and other features, aspects, and advantages will become more apparent from the following detailed description when read in conjunction with the following drawings.

FIG. 1 depicts an exemplary communication network according to an embodiment of the invention.

FIG. 2 depicts the relationship between the terminal document representation resident within the terminal and the terminal specific representation resident within the XML Proxy, according to embodiments of the invention.

FIG. 3 depicts an exemplary XML Proxy containing many representations of an XML Document, some representations being primarily concerned with efficiency and applicability to a specific terminal or class of terminals, while other representations are not concerned with interoperability and standardization as examples, according to embodiments of the invention.

FIG. 4 depicts main aspects of methods and classification ranges for the steps of the methods, according to embodiments of the invention.

FIG. 5A depicts an exemplary discovery method and associated steps, according to embodiments of the invention.

FIG. 5B depicts an exemplary of the discovery method utilizing the IETF XCAP protocol in conjunction with an OMA Aggregation Proxy node, according to an embodiment of the invention.

FIG. 6A depicts an exemplary processing method and associated steps, according to embodiments of the invention.

FIG. 6B depicts an exemplary translation method and associated steps, according to embodiments of the invention.

FIG. 7 depicts exemplary discovery messages that can be used when applying the discovery method to a SIP (Session Initiation Protocol) communications exchange, according to embodiments of the invention.

FIG. 8 depicts exemplary discovery messages that can be used when applying the discovery method to a HTTP (Hypertext Transfer Protocol) communications exchange in conformance to the standards as specified by the Open Mobile Alliance, according to embodiments of the invention.

### Glossary

A glossary is provided for an explanation of the following terminology.

Aggregation Proxy—a network entity adhering to the OMA POC committee definition of an Aggregation proxy.

SIP—Session Initiation Protocol.

IMEI—International Mobile Equipment Identity

IMS—IP Multimedia Subsystem. An All-IP wireless system, where data, voice and signaling are all carried as IP packets.

IP—Internet Protocol.

OMA—Open Mobile Alliance.

OSE—Open Security Exchange.

Terminal—a device within a communications network, fixed or wireless, which is used by a network subscriber, user, or other individual entity to leverage the communications capabilities of the network. Also known as “User Equipment.” Examples of a terminal would include devices able to operate in the role of an XCAP XML Data Manipulation Client.

XCAP—XML configuration access protocol.

XDMC—XML Document Management Client.

XML Proxy—a network entity present within a communications path and adjacent to an Aggregation Proxy.

XML—Extensible Markup Language.

### DETAILED DESCRIPTION

The invention is described with reference to specific apparatus and embodiments. Those skilled in the art will recognize that the description is for illustration and to provide the best mode of practicing the invention. Variations will be apparent to those of skill in the art, for example, while the disclosed embodiments are directed to wireless communication, the invention is applicable to any type of communication. Likewise, while reference is made to XML data representations within network communications protocol, any protocol can be employed consistent with the description of the invention set forth herein.

A. Architecture

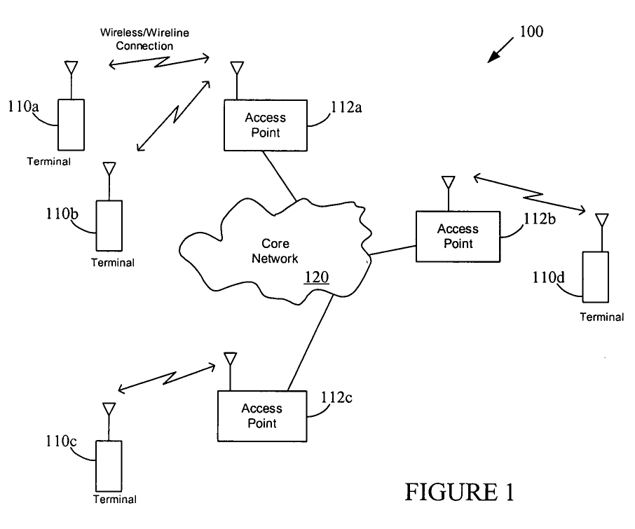

FIG. 1 depicts an exemplary communication network 100 according to an embodiment of the invention. Terminals 100a-d communicate with Access Points 112a-c and a core network 120. In one aspect of the invention, the core network is a private communications network Internet. In another aspect of the invention, the core network is the Internet. In yet another aspect of the invention, the core network is a combination of private and public networks. Also, while the exemplary communication network depicts wireless terminals and network entities, wired terminals and network entities may also be used with the invention. In addition, personal area networks, infrared or optical networks could also be used.

The invention involves a network entity that is able to process specific types of network based communications traffic utilizing XML based strategies in order to reduce the costs for other entities, transmitting, or receiving the XML data and having a responsibility for processing the XML information or data.

If the discovery method fails then the inventive method reverts to conventional XML communications exchanges formerly used prior to the introduction of this method into a communications network.

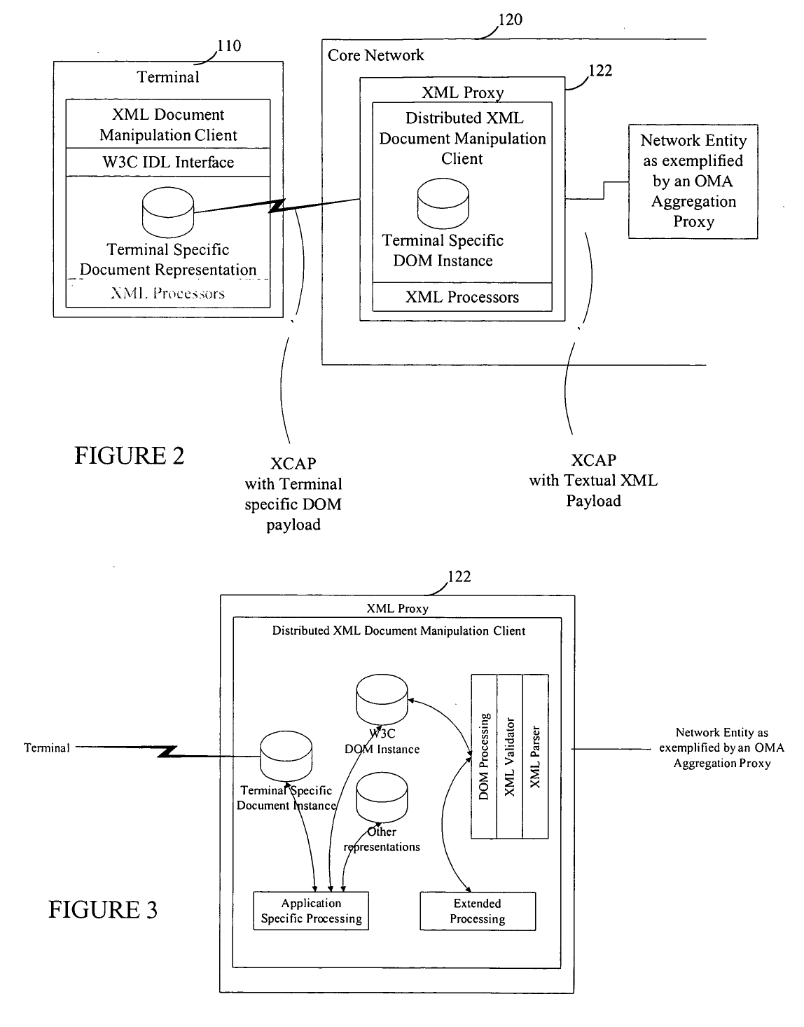

FIG. 2 depicts a terminal 110 and core network 120 depicting logical structures for use in the invention. FIG. 2 depicts a relationship between the XML document representation resident within the terminal and the terminal specific representation resident within the XML Proxy structure 122 of the core network, according to embodiments of the invention. These representations are complimentary to one another as explained in more detail below.

FIG. 3 depicts an exemplary XML Proxy 122 containing many representations of an XML Document, some representations being primarily concerned with efficiency and applicability to a specific terminal or class of terminals, while other representations are concerned with interoperability and standardization as examples, according to embodiments of the invention. The XML Proxy stores these representations for use with different terminals. For example, a terminal that wishes to communicate using a particular protocol can be promptly satisfied by the XML Proxy using a Document, or fragment of a Document, representation that complies with that particular protocol. As a further example, a terminal that has specific requirements or constraints can be promptly satisfied by the Proxy using a representation that complies with such specific requirements or other limitations. Naturally a portion of an XML document may include one or more fragments or the whole portion thereof.

Document representations used within the XML Proxy are negotiated between the Proxy and the terminals, and network entities with which it is communicating. The representations chosen by the XML Proxy can be chosen based upon the balance of savings experienced in storage requirements, processing costs and other factors on the terminal, other network entities, and within the XML proxy. Also taken into consideration the time and economic costs required to transmit and receive document information across the communications infrastructure between the terminal and the XML Proxy.

Further the XML Proxy possessing knowledge of what space, time or cost efficient representations that specific terminals desire can further communicate with said terminals using the single most cost effective representation from the plurality of representations it posses.

Further, a terminal can support more than one form of representation for individual XML documents, fragments, or data and will be able to have candidate representations chosen by the terminal on the basis of the Schema, Document Type Definition or document formalisms known to the terminal and believed to have optimal representations.

The XML Processor functions located both in the terminal and in the XML Proxy server and can be activated by the terminal depending upon its requirements. An exemplary method uses an algorithm, potentially predictive in nature, to determine what the trade-off between any constraining factors is optimal for any specific situation. It is anticipated that methods such as those described in, U.S. Ser. No. 11/009,899 “Application for Dynamic Compression Training Method And Apparatus” (SONM-P003), incorporated herein by reference, can be utilized in addition to fixed algorithms for determining where specific XML Processes would be performed enabling adaptation of this method to a variety and plurality of constraints observed in terminals, and other network entities.

Examples of the discovery and communication applied to the exemplary architecture are described in detail below.

B. Methods of Operation

In order to successfully process XML on behalf of devices, the invention employs a two-stage technique. First, a discovery method is described and an example is provided to illustrate how discovery is performed within a communications network to determine if the body of the method can be utilized. Second, a processing method is described that details how terminals and the XML Proxy within a network cooperate to reduce the processing and storage costs for a constrained terminal, or other device when handling complex structured data, as exemplified by XML.

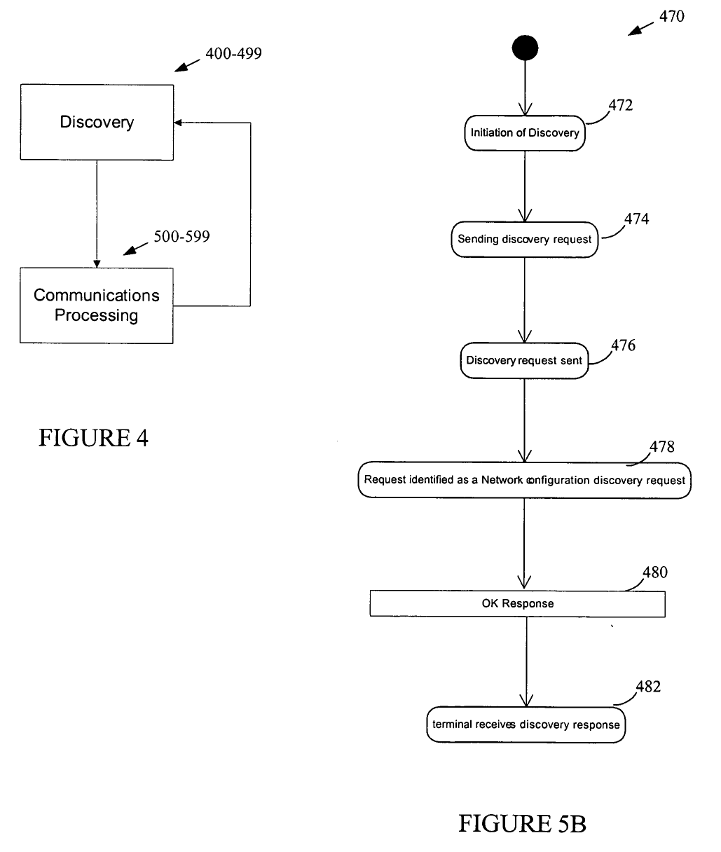

FIG. 4 depicts main aspects of methods and classification ranges for the steps of the methods, according to embodiments of the invention. Within this section two high level methods are described: steps 400-499 are directed to a method, called the discovery method, by which terminals and other network entities can determine if they jointly or severally can apply the processing method. Steps 500-599 are directed to a method called the processing method.

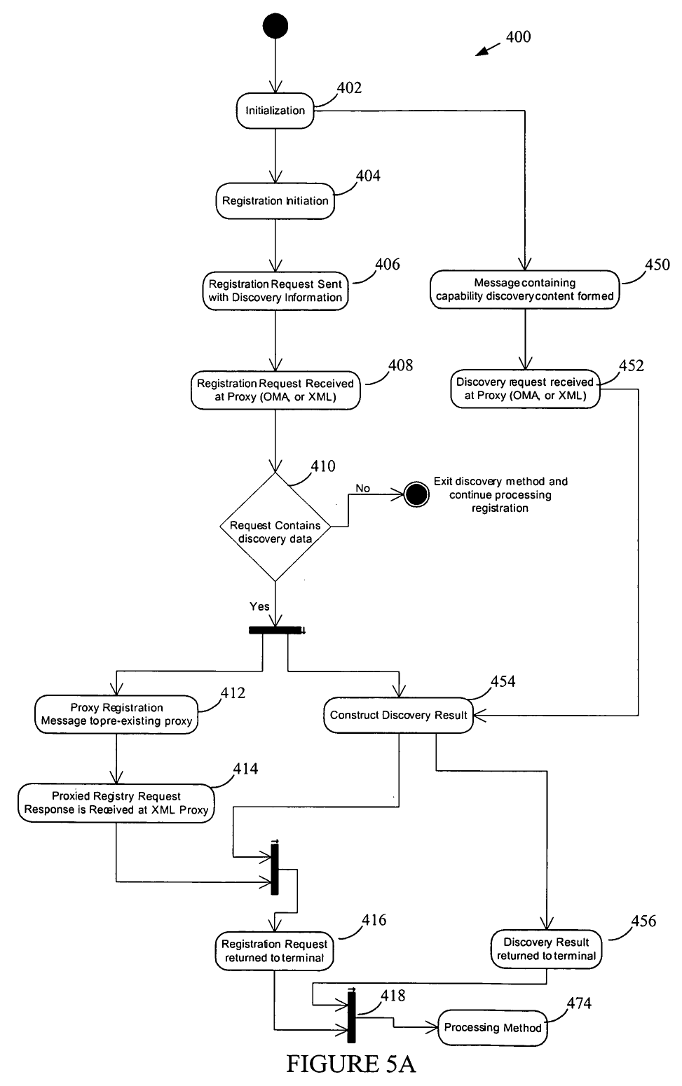

FIG. 5A depicts an exemplary discovery method 400 and associated steps, according to embodiments of the invention. The discovery method is used by a terminal upon connecting to, reconnecting to, or performing communications transactions within a communications network establishing its existence within the network using a registration process or procedure. The terminal advertises its capabilities and its desire to leverage the benefits of this method using the communications network registration process or procedure.

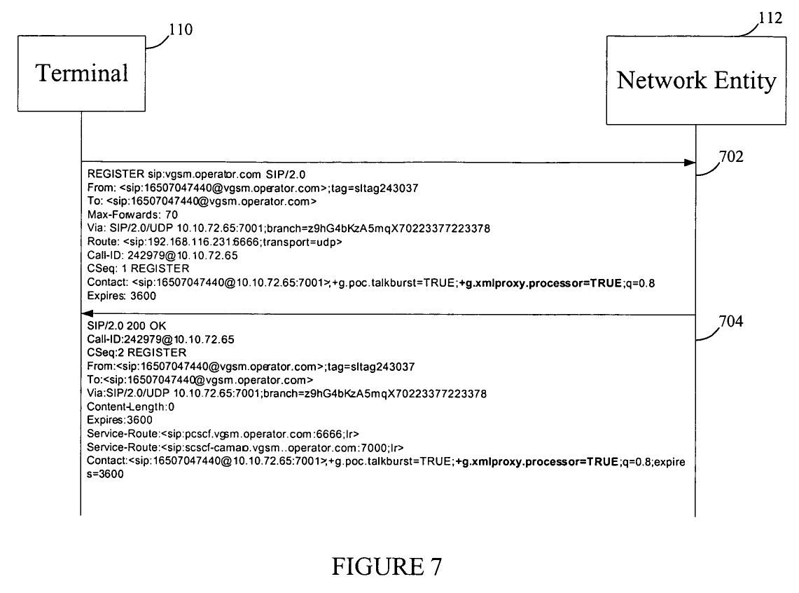

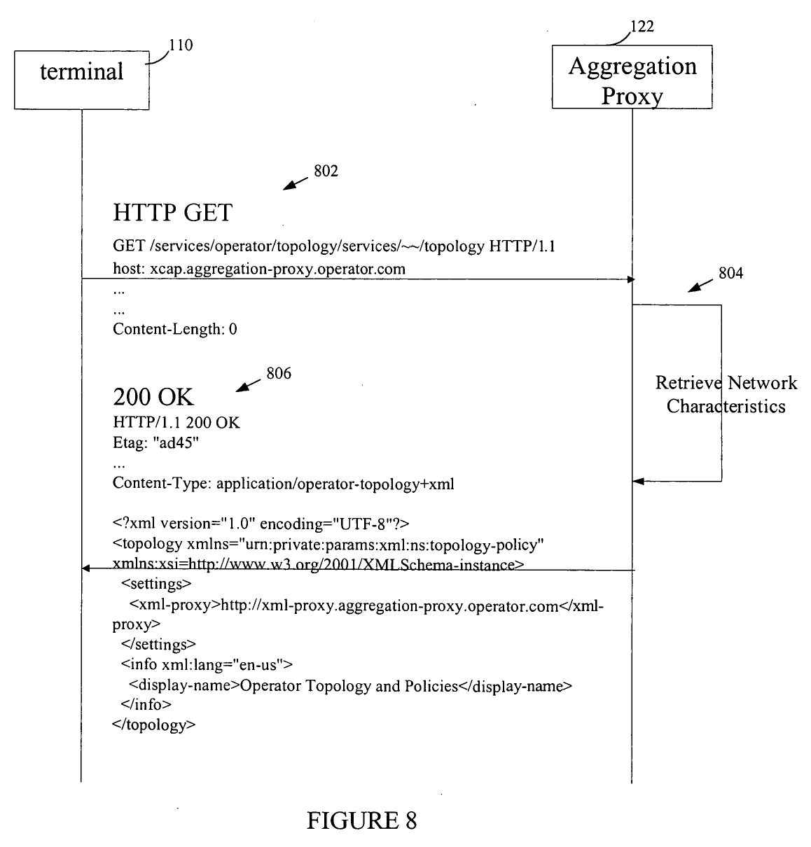

A registration procedure used by a terminal is exemplified by 3GPP IMS SIP based signaling and the REGISTER procedure originated by the terminal containing a SIP feature tag such as “+g.xmlproxy.processor=‘TRUE’”. Implicit registration for the XML processor could also leverage the knowledge that communications network entities may be provisioned with this capability being associated with the terminal using a unique identifier such as and IMEI or subscriber identifier, as exemplified in FIGS. 7-8, described below.

Referring to FIG. 5A, the method is initialized in step 402. In step 404, a terminal capable of supporting the distributed XML processing method initiates a registration procedure to both characterize and establish its initial and subsequent ongoing communications paths employed between communications entities. In step 406, the terminal encapsulates information within communications messages that form the parts of registration-procedure information concerning its ability to become a part of a distributed XML processing system. In step 410, a proxy component detects the presence of a capability-discovery component within the communications protocol employed during the registration procedure and acts to instantiate the entities, components, sub-systems or other constituent parts of the dynamic XML processing system. In step 414, the registration procedure communications protocol message returns from network entities being proxied. In step 416, the proxy appends to the resulting communications messages, forming part of the registration procedure defined by the communications protocol, the appropriate response to the terminals advertising of its ability to support the distributed XML processing method. In step 418, network communications entities—specifically the XML Proxy—use their classification of the terminal to leverage the proxy's enhanced processing capabilities to intercept communications involving XML data or information and operate on that data to transform it into a form that can be readily processed by terminals and/or other network entities at a reduced cost when compared to the original XML, or other data. As previously mentioned the reduction may include transforming the document into a format that reduces the processing requirements of the receiving terminal or it may include translation to an intermediary format that will require reduced network bandwidth for transmission to the terminal. The method can also be used to produce additional processing benefits in addition to these two mentioned. In some protocol usages, such as the OMA XDMS example, one XML document retrieved may contain references to other documents that are required for the terminal to make use of the originally requested XML document. In this situation the proxy employed using the method described here may pre-fetch the additional document or documents and substitute the external reference for the actual target data needed. This would have the effect of reducing the processing overhead of the terminal making additional network requests and reduce the workload of the terminal to process this document.

In some cases Network Operators may not prefer certain steps embodied within the discovery method as it affects Core Network entities that may have been deployed prior to implementing the methods describe herein. The following alternative steps 450-456 are therefore described as an additional exemplifier of the discover method, also shown within FIG. 5A. Terminals may also make use of the standard features of an OMA Aggregation Proxy to perform discovery of network topology and determine if this and other methods can be employed to enhance their XML communications and processing capabilities as exemplified within FIGS. 7-8, described below. In this case the Aggregation Proxy would respond to specific types of requests for XML based configuration information. In step 452, the Aggregation Proxy is configured or provisioned with information regarding the topology and deployment architecture and information concerning a network operators deployment choices, including if a network component exists that would be able to support the XML processing methods described within this method. Concerning step 452, terminals performing discovery can utilize the OMA Aggregation Proxy to obtain network topology, feature configuration information, and characteristics of network entities in regards to locating the XML Proxy component. In this case a terminal would initiate communications to obtain XML information concerning network characteristics using the standard OMA Aggregation Proxy protocol with conventional XML content, without having to utilize the registration procedures of other protocols. Upon obtaining the XML configuration information the terminal would then be able to make a determination that certain enhancements to the Aggregation Proxy are available and any relevant information needed to correctly interact with the network entity assigned the role of employing the processing method described herein.

Further to the exemplary case where the terminal obtains a document describing if this method or other network enhancements are available using the discovery method the following steps are defined, and shown in FIG. 5B, as an exemplar of the discovery method.

In step 472, the terminal (implementing an OMA XDMC) begins initializing the discovery method. In step 474, the terminal commences the discovery method. In step 476, the terminal (XDMC) sends a HTTP GET request to the Aggregation Proxy. In step 478, based on the AUID the Aggregation Proxy determines the request is related to the operator network configuration XDMS. In step 480, after the Aggregation Proxy has performed the necessary authorization checks on the request originator, the configuration XDMS sends an HTTP “200 OK” response including the requested document in the body through the Aggregation Proxy indicating the presence of an XML proxy. In step 482, the Aggregation Proxy routes the response to the XDM Client.

Further to the example shown in FIGS. 7-8, described below, the discovery method can be exemplified by XCAP (HTTP based communications with an XML payload) with network entities such as an XML Proxy. The terminal registers with the network and upon obtaining a valid registration response to the SIP feature tag, “+g.xmlproxy.processor” the proxy detects this and tag and processes the request according to the procedures outlined in the method herein. As an alternative example the XCAP discovery based method can also be employed, the terminal would communicate with the XML Proxy with some indication of its desire to use XML payloads employing distributed XML processing methods using HTTP headers or some other mechanism permitted within the XCAP protocol.

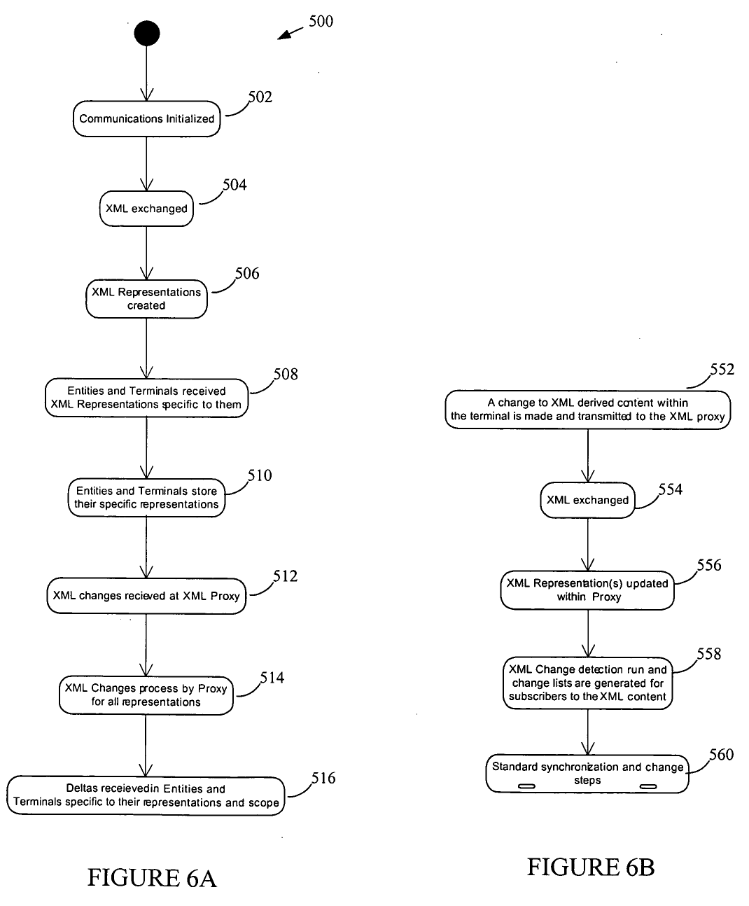

FIGS. 6A-B are directed to the processing portion of the method shown in FIG. 4. FIG. 6A depicts an exemplary processing method and associated steps, according to embodiments of the invention.

In reference to FIG. 6A, the communications path between the XML Proxy and the terminal is provisioned using a communications protocol, as exemplified by XCAP. The method described herein enables synchronization and data manipulation of a terminal specific document representation shared by the terminal and the XML Proxy. Simple deltas are sent between the terminal and said proxy to maintain synchronization. In step 502, communications have been commenced utilizing a communications protocol or protocols utilizing XML document or XML content. In step 504, communications exchanges utilizing, or resulting in responses consisting of or containing XML document requests are passed through an XML proxy fetching a full XML document, or an XML fragment on behalf of a terminal. In step 506, the XML proxy processes document into DOM, terminal specific, and other useful representations that will be employed by terminals, for example application specific data structures. In step 508, the XML proxy transmits to terminals specific representations of XML intended for the terminal represented in a terminal native format, or other representation. In step 510, terminal stores and processes the transmitted representation, or representations of XML document or XML fragment. In step 512, the XML proxy receives a message, notification, or instruction to manipulate the XML document, fragment or other XML content on the basis that an external entity providing the XML has detected a change, as typified by XCAP and other XML manipulation features, functions, or strategies. In step 514, the XML proxy processes changes against the plurality of representations it has stored generating and storing the specific differences generated by changes. In step 516, the terminal specific representation changes generated during step 250 are then prepared for transmission and sent to the terminal as a set of change requests for the native terminal representation or the specific representation selected for the terminal or network entity.

FIG. 6B depicts an exemplary translation method and associated steps, according to embodiments of the invention. In step 552, a change to XML derived content with the terminal is made and transmitted to the XML proxy. In step 554 a terminal, or network entity, wishing to make changes to XML stored within the terminal makes changes to the representation specific to the terminal or network entity that is making the changes. The changes are then sent as a set of changes to the XML proxy. In step 556 the XML Proxy makes changes to the specific representation of the XML utilized by the terminal or network entity stored internally and then determines the changes that are implied for the DOM based representation and makes these changes. In step 558 a change detection algorithm, or similar strategy as appropriate, is run across the DOM representation and is used to generate standardized XCAP style changes that will be sent for this document to the standardized XDMS infrastructure, in addition changes are also applied directly to the other XML representations stored within the XML Proxy for other network entities or terminals reducing the need to apply changes requests twice. In step 560, changes are transmitted to other entities and terminals with subscriptions to the XML content changed as detailed in step 508.

C. Exemplary Discovery Message Implementations of the Invention

A referenced above, the invention is provided for the exchange of messages between devices that communicate using alpha-numeric message representations. FIGS. 7-8 are provided to demonstrate practical examples of the invention applied to communications.

FIG. 7 depicts exemplary discovery messages that can be used when applying the discovery method to a SIP (Session Initiation Protocol) communications exchange, according to embodiments of the invention. The terminal 110 initiates the discovery process through a registration message 702 corresponding to flowchart 400 described above. Then the core network 120 provides a response message 704 accepting the registration and providing an XML document associated with the terminal characteristics corresponding to flowchart 500 described above.

FIG. 8 depicts exemplary discovery messages that can be used when applying the discovery method to an HTTP (Hypertext Transfer Protocol) communications exchange in conformance to the standards as specified by the Open Mobile Alliance, according to embodiments of the invention. The message 802 is a discovery and registration process where the proxy receives the terminal information corresponding to flowchart 470 where the terminal initiates discovery beginning with step 472. The proxy identifies and retrieves the network characteristics depicted by reference 804 corresponding to step 478. The response message 806 is then sent to the terminal corresponding with step 482.

The discovery method can be exemplified by XCAP (HTTP based communications with an XML payload) with network entities such as an XML Proxy. The terminal registers with the network and upon obtaining a valid registration response to the SIP feature tag, “+g.xmlproxy.processor”, or the XCAP discovery based method, would communicate with the XML Proxy with some indication of its desire to use XML payloads employing distributed XML processing methods,

D. Aspects of the Invention

Aspects of the invention are described below which may be used in conjunction with the described embodiments of the invention, while not necessarily required to implement such embodiments. When using the processing method an XML Proxy processes XML components within communications protocols originating from or terminating in network entities before the information is transmitted to or received from terminals, or other network entities.

An aspect of the method differs notably from the OMA compression role for the Aggregation Proxy in that the information or data being processed has not necessarily undergone transformation from a Document Object instance as directly operated on by the terminal to an XML final form Markup usually handled by the Aggregation Proxy.

The XML proxy function reduces the processing, and communications costs, overhead, latencies and memory overhead for terminals by transforming XML document objects to and from the terminal representation(s) and the conventional textual XML content representation suitable for conventional transmission as a part, or portion of communications protocols, the XCAP communications protocol is an exemplar of a protocol suitable for application of this method.

In addition the exemplary XML Proxy is also able to receive networking communications data, information, or traffic intended for terminals from other network entities and pre-process the communications protocol XML components within these requests to reduce the terminal, or other network entities processing, memory overhead, or latencies required to obtain a useful document object instance once the communication has been received.

The processed XML communications components, or content originating from the XML proxy, network entities, or terminals reflect a form that is native to the terminals, or network entities indicated and can be manipulated and used by terminals without the normal XML parsing, validation, document loading, and other XML processing, functions required for conventionally, or textually represented XML.

Consequently, thereby terminals and network entities are able to offload XML processing normally required before transmitting, or after receiving communications protocol XML components. XML Proxy processed XML received by the terminal are prepared for standardized XML storage within the XML Proxy using a Document Object Model (DOM) based representation, and potentially many other XML representations, including those specific to terminals, and other network entities, or to the XML processing software framework being used within the terminal by simply streaming or de-serializing the XML content received directly into the specific data structures being used within the terminal or network entity using minimal processing.

It should also be noted that the terminal specific instance of the XML Document(s) or Fragment(s) can include functionality for compression and other resource saving strategies affecting the document object model processing performed within the XML proxy.

The XML proxy possessing knowledge about the document storage and processing implementations present within terminals stores one or more representations of said XML. This enables the XML proxy to perform XML processing on a variety of representations and to reflect the results to various terminals based upon their favored representation, or representations. Having at least one DOM compliant representation enables the XML proxy to perform DOM, and consequently conventional and standards compliant XML Processing. Representations specific to terminals can then be handled in any appropriate manner based upon analysis of the results of the XML processing operations performed in a suitable manner on other representations.

As the scope of XML processing performed in the XML standards includes XQuery processing, XPath navigation, and XDiff processing, the XML proxy having knowledge of the client applications and terminal implementations can determine which fragments or portions of XML stored are required for the terminal to operate correctly. The XML proxy in these circumstances could limit visibility of the terminal specific representation(s), i.e. acting as a logical and physical filter, it has available to those portions of the document that the terminal(s) will operate on while still retaining the integrity of the XML being processed and the process itself. In this manner the bandwidth required, and the number of interactions needed between the terminal and the XML Proxy can be reduced to the absolute minimum.

FIG. 3 shows an example of storing multiple document representations within the XML Proxy with one of the many possible XML processing systems represented.

Further the functionality described within this method could be deployed in devices such as the OMA Aggregation Proxy. When deployed specifically in an existing OMA network device this method would be implemented as a processing entity similar in fashion, but not function, to the XML compression entity described by the OMA. In this manner the XML Proxy component embedded into an OMA Aggregation Proxy is used to enhance already existing XML communications strategies and technologies.

Further, SIP Based Event Packages can be constructed containing XML Content as an exemplifier of a communications protocol containing XML payloads relevant to this invention and exemplars of this invention.

Additional aspects and variations on the embodiments and aspects of the invention are anticipated.

E. Conclusion

Advantages of the invention include that equipment within the communications path can partially process information and data, for example XML, on behalf of the receiving, and/or transmitting device (e.g. User Equipment, terminal, or other network entity/servers acting as terminals) to reduce the overhead of handling the information once it has arrived at its destination. The invention enables the savings to be made without disrupting devices already present within a communications network, for example IMS or OMA OSE, should terminals not able to utilize this method be part of the communications network. As a result, the invention provides an efficient XML discovery and processing that is more efficient than conventional techniques, while also more customizable for a variety of different terminal parameters, terminal constraints, and application usages.

Having disclosed exemplary embodiments and the best mode, modifications and variations may be made to the disclosed embodiments while remaining within the subject and spirit of the invention as defined by the following claims.

1. A communication network, comprising:
a terminal tailored to communicate with said network; and
an XML proxy structure, resident in said network, containing a plurality of representations of a portion of an XML document for communication with the terminal.

2. The communication network of claim 1, wherein:
the representations of a portion of an XML document include at least one representation for efficiency and applicability to a specific terminal or class of terminals, and at least one other representation for interoperability with terminals.

3. The communication network of claim 1 for the purpose of distributing XML processing
across a communications infrastructure to reduce costs, wherein:
the representations of a portion of an XML document include at least one representation for efficiency and applicability to a specific terminal or class of terminals, and at least one other representation for interoperability with terminals.

4. The communication network of claim 1, further comprising:
a translation structure, resident in said network, configured to create suitable representations of a portion of an XML document for a plurality of different terminals.

5. The communication network of claim 1, further comprising:
a management structure, resident in the core network, configured to provide network operators network topology information through and within an OMA compliant Aggregation Proxy in order to communicate and describe available network services or features, or enhancements to said services and features.

6. A method of communicating between a terminal tailored to communicate with said
network; and an XML proxy structure, resident in the core network, comprising the steps of:
the terminal initiating a session by registering with said network;
the XML proxy structure containing representations of a portion of an XML Document, at least one representation for efficiency and applicability to a specific terminal or class of terminals, and at least one other representation for interoperability with terminals;
the XML proxy structure associating the terminal with at least one XML Document, called the proxy document; and
the network communicating the proxy document to the terminal.

7. The method of claim 6, wherein:
the representations of an XML document include at least one representation for efficiency and applicability to a specific terminal or class of terminals, and at least one other representation for interoperability with terminals.

8. The method of claim 6 for the purpose of distributing XML processing across a
communications infrastructure to reduce costs, wherein:
the representations of an XML document include at least one representation for efficiency and applicability to a specific terminal or class of terminals, and at least one other representation for interoperability with terminals.

9. The method of claim 6, further comprising:
a translation structure, resident in the core network, configured to create suitable representations of XML for a plurality of different terminals.

10. The method of claim 6, further comprising:
a management structure, resident in the core network, configured to provide network operators network topology information through and within an OMA compliant Aggregation Proxy in order to communicate and describe available network services or features, or enhancements to said services and features.
